(19) United States
(12) Patent Application Publication
(10) Pub. No.: US 2008/0239719 A1
(43) Pub. Date: Oct. 2, 2008

(54) Method and device for lighting for dentists and other professionals

(76) Inventors: Vladimir Kats, Yokneam (IL); Hirsch Nitzan, Tel Aviv (IL); Alexander Tiomkin, Verona (IT)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/731,845

(22) Filed: Apr. 2, 2007

(51) Int. Cl. F21V 21/32; F21V 21/28; F21V 21/088

(52) U.S. Cl. 362/232; 362/239; 362/804; 362/419

(57) ABSTRACT

A light fitting with attachment to apparatus near a work area. Flexible and extendable connections to the bulbs of the light. Strong lighting bulbs attached to flexible and soft housings. Extendable and retractable portions of the said fitting to bring focused light as close as possible to the work area. Option of sensors to avoid collision with moving bodies.

### FIELD OF THE INVENTION

This invention is in the field of lighting fixtures and in particular as they apply to dentists and other professionals and work environments.

### BACKGROUND OF THE INVENTION

This invention comes to solve the difficulty professionals and dentists in particular experience when they need the best quality lighting to see the area on which they are working. Surgeons have a similar need for such lighting and many other areas of work for example, a car mechanic who is working under a vehicle. All these examples are cases where the professional needs to see the area of his work which is usually in a constricted place where visibility is often poor or partially obstructed and the professional's own body often obstructs the light from reaching the work area. This invention reveals a method of lighting that to a significant extent solves these lighting problems.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

This invention reveals a kind of lighting fixture that is made to clamp onto nearby structures like existing lighting stands or a purpose built structure for example suspended from the ceiling or an attachment to a nearby table by clip screw and the like. This would allow greater flexibility positioning the light fitting to be at an angle that would best light up the work area without interference of the professionals own body or some other object creating a shadow.

The lights used could be led lights or other suitable kinds of light, with one or more individual led lights having the ability to be adjustably extended to shine closer to the working surface. The whole lighting device and particularly the said light extension would be made of soft materials that would not cause injury when coming in contact with a person.

This arrangement would have the effect of giving increased lighting on the general area around the work area and a concentrated focus of light on the actual work area.

The lighting device and independently the extended light would be extendable, retractable and flexible to cover maximum angles and positions needed by the professional in the course of his work. A number of light switches would operate the various light features of this invention.

The adjustments of the light fitting could be manual or electrically assisted. There could be an automatic retracting feature whereby sensors would detect an object approaching and retract before contact is made. Such a feature would be beneficial to this invention as the light fitting or parts of it are positioned close to the working area of the user. The latter would not want to worry constantly that he may collide with the light fitting.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic diagram of the light fitting for professionals.

FIG. 2 is a schematic diagram of the center section of the light fitting showing the extended led light.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

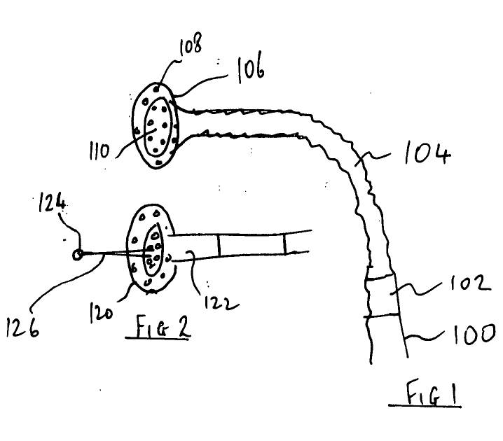

FIG. 1 shows the upper end of the light fitting 100 of this invention. A portion of this fitting is telescopic 102 being adjustable manually or electronically. Another portion of the fitting is made of flexible material 104 to aid the user to find the best angle for the light.

The head 106 of the light fitting 100 could be various shapes or sizes with many bulbs for example led lights 108 with a curved reflector 110 behind the bulbs.

The center portion of the head 106 could be extractable and retractable as described in more detail in FIG. 2.

FIG. 2 shows the extended center portion of the light fitting of this invention. The center 120 could be extended on from the main light fitting by means such as telescopic 122 or retractable cable. This extension 122 could be soft and flexible to prevent injury by a person colliding with it.

The bulbs in the center 120 would bring the light stronger and more focused on the work area than that from the main light fitting; Another feature is the further extension of one or more lights 124 on a flexible cable 126 that could bring focused light onto the area of work. This cable 126 could also be soft to avoid any injury if a person collided with it.

What is claimed: The present invention is not intended to be limited to the embodiments described above, but to encompass any and all embodiments within the scope of the following claims.

1. A light fitting comprising,
a. a clamp to grip onto a nearby structure,
b. an extendable and retractable support,
c. at least one light bulb with a reflection plate,
d. at least one light bulb extendable and retractable from and to the said reflection plate,
e. at least one light bulb extendable and retractable from and to the said extendable light bulb,
f. light bulb extensions and support material are flexible and made from padded material, whereby dentists and others could work in a well lit working area.

2. A light fitting as claimed in claim 1 wherein the said light bulb is a led light.

3. A light fitting as claimed in claim 1 wherein said extension and retraction is by telescopic technology.

4. A light fitting as claimed in claim 3 wherein the said extension and retraction is manually adjustable.

5. A light fitting as claimed in claim 3 wherein the said extension and retraction is electrically adjustable.

6. A light fitting comprising,
a. a clamp to grip onto a nearby structure,
b. an extendable and retractable support,
c. at least one light bulb with a reflection plate,
d. at least one light bulb extendable and retractable from and to the said reflection plate,
e. at least one light bulb extendable and retractable from and to the said extendable light bulb,
f. light bulb extensions and support material are flexible and made from padded material,
g. at least one distance sensor that would avoid collision between the said bulbs and fittings and approaching objects.
whereby dentists and others could work in a well lit working area.

7. A light fitting as claimed in claim 6 wherein the said light bulb is a led light.

8. A light fitting as claimed in claim 6 wherein said extension and retraction is by telescopic technology.

9. A light fitting as claimed in claim 8 wherein the said extension and retraction is manually adjustable.

10. A light fitting as claimed in claim 8 wherein the said extension and retraction is electrically adjustable.
